(19) United States
(12) Patent Application Publication
(10) Pub. No.: US 2004/0039751 A1
(43) Pub. Date: Feb. 26, 2004

(54) Method and apparatus for characterizing a design function

(75) Inventors: Narendra Amalendu Soman, Niskayuna, NY (US); Hari Prasad Kondamadugula Reddy, Bangalore (IN)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company

(21) Appl. No.: 10/226,719

(22) Filed: Aug. 23, 2002

(51) Int. Cl. G06F 17/30

(52) U.S. Cl. 707/104.1

(57) ABSTRACT

An apparatus for characterizing a design function, the apparatus comprising: a first perturbation module adapted for writing a first perturbed input value into an input cell of an input spreadsheet to generate a first perturbed output value of an output cell of an output spreadsheet; and a sensitivity calculator adapted for calculating a design function sensitivity from the first perturbed input value and the first perturbed output value.

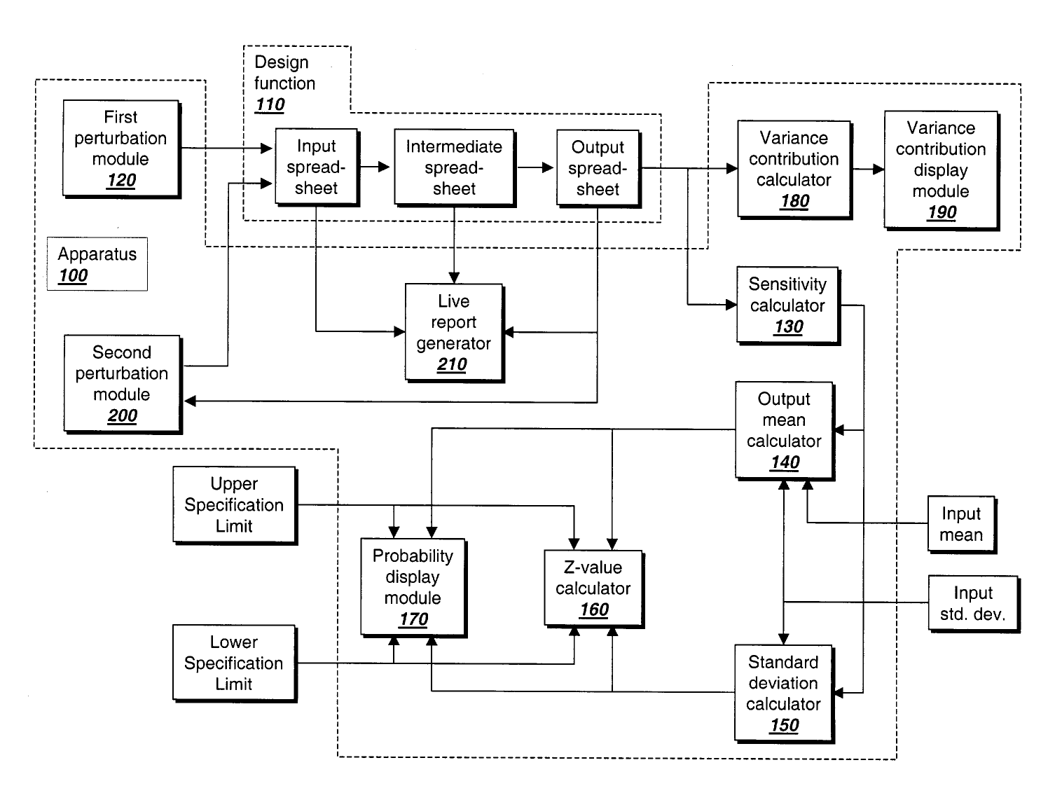

### BACKGROUND

The present invention relates generally to the field of software applications and more specifically to a method and apparatus for characterizing a design function wherein the design function is implemented as one or more spreadsheets.

In a wide variety of engineering design applications, spreadsheets are used to simulate characteristics of candidate designs. These spreadsheets implement design functions which produce performance estimates as functions of numerous adjustable parameters and input quantities. For example, a gas turbine engine design function uses compressor pressure ratio and turbine inlet temperature as adjustable parameters, ambient temperature as an input quantity, and produces performance estimates of thermodynamic cycle efficiency.

As part of the design process, it is often desirable to characterize the design function with respect to the statistical behavior of the performance estimates as the adjustable parameters and input quantities are allowed to vary randomly according to prescribed input probability distributions. These input probability distributions are often assumed to be Gaussian with known input means and input standard deviations. Characterization of the design function then comprises calculating design function sensitivities from which output means and output standard deviations of the performance estimates are then derived.

Various tools exist which aid in calculating the design function sensitivities for characterizing a design function. Typically, such existing tools require that the design function be implemented as only a single formula cell of a single spreadsheet. Such an implementation restricts the application to only single performance estimates of relatively simple design functions.

In many applications, however, the design function is implemented using multiple spreadsheets and generates multiple performance estimates of interest. Existing tools are not adapted for characterizing design functions expressed across multiple spreadsheets, nor for calculating design functions defined with multiple output performance estimates.

Opportunities exist, therefore, to develop a tool that enables the characterization of design functions defined using multiple output performance estimates and that are expressed across multiple spreadsheets.

### SUMMARY

The opportunities described above are addressed, in one embodiment of the present invention, by an apparatus for characterizing a design function, the apparatus comprising: a first perturbation module adapted for writing a first perturbed input value into an input cell of an input spreadsheet to generate a first perturbed output value of an output cell of an output spreadsheet; and a sensitivity calculator adapted for calculating a design function sensitivity from the first perturbed input value and the first perturbed output value.

### DRAWINGS

These and other features, aspects, and advantages of the present invention will become better understood when the following detailed description is read with reference to the accompanying drawings in which like characters represent like parts throughout the drawings, wherein:

The FIGURE illustrates a block diagram of an apparatus in accordance with one embodiment of the present invention.

### DETAILED DESCRIPTION

In accordance with one embodiment of the present invention, the FIGURE illustrates a block diagram of an apparatus 100 for characterizing a design function 110, the apparatus 100 comprising a first perturbation module 120, a sensitivity calculator 130, an output mean calculator 140, a standard deviation calculator 150, a z-value calculator 160, a probability display module 170, a variance contribution calculator 180, a variance contribution display module 190, a second perturbation module 200, and a live report generator 210.

In operation, first perturbation module 120 writes a first perturbed input value into an input cell of an input spreadsheet to generate a first perturbed output value of an output cell of an output spreadsheet. From the first perturbed input value and the first perturbed output value, sensitivity calculator 130 calculates a design function sensitivity. Output mean calculator 140 calculates an output mean from the design function sensitivity and from an input mean, and standard deviation calculator 150 calculates an output standard deviation from the design function sensitivity and from an input standard deviation. From the output mean, the output standard deviation, an upper specification limit, and a lower specification limit, z-value calculator 160 calculates a z-value.

As used herein, a “z-value” refers to any measure of the ability of a probability density function having the output mean and output standard deviation to satisfy the upper specification limit (USL) and the lower specification limit (LSL). In typical embodiments, the z-value is calculated by: assuming the output mean and output standard deviation refer to a Gaussian probability density function (GPDF); summing the areas under the GPDF to the left of the LSL and to the right of the USL to yield a total defect probability; calculating a single sided limit (SSL) wherein the area to the right of the SSL is equal to the total defect probability; and taking the ratio of the SSL to the output standard deviation to yield the z-value.

Probability display module 170 displays a bell curve using the output mean and the output standard deviation. In some embodiments, probability display module 170 also displays the upper specification limit and the lower specification limit as vertical lines on the bell curve.

Second perturbation module 200 writes a second perturbed input value into the input cell to generate a second perturbed output value of the output cell, the second perturbed input value being greater than the first perturbed input value. Second perturbation module 200 also displays the second perturbed output value.

Live report generator 210 implements a method for generating a live report. The method comprises generating a live report spreadsheet, copying the input spreadsheet to a copied input spreadsheet, copying the output spreadsheet to a copied output spreadsheet and optionally, copying at least one intermediate spreadsheet to at least one copied intermediate spreadsheet, the at least one intermediate spreadsheet linking the input spreadsheet to the output spreadsheet. The live report input cell of the live report spreadsheet is linked to a copied input cell of the copied input spreadsheet, the copied input cell corresponding to the input cell of the input spreadsheet. The live report output cell of the live report spreadsheet is linked to a copied output cell of the copied output spreadsheet, the copied output cell corresponding to the output cell of the output spreadsheet.

In another embodiment, variance contribution calculator 180 calculates a plurality of variance contributions from respective ones of a plurality of design function sensitivities. The design function sensitivities correspond to respective ones of a plurality of input cells. In this embodiment, first perturbation module 120 writes a plurality of first perturbed input values into corresponding ones of the plurality of input cells and sensitivity calculator 130 calculates the plurality of design function sensitivities. Variance contribution display module 190 displays the variance contributions using a bar chart.

In a more detailed embodiment in accordance with the embodiment of the present invention, output mean calculator 140 uses a second order approximation for calculating the output mean. The second order approximation multiplies an approximate second derivative, calculated from the first perturbed input value and first perturbed output value, by the input standard deviation to yield a second order correction to the output mean.

First perturbation module 120, sensitivity calculator 130, output mean calculator 140, standard deviation calculator 150, z-value calculator 160, probability display module 170, variance contribution calculator 180, variance contribution display module 190, second perturbation module 200, and live report generator 210 comprise any electrical or electronic device or system capable of performing the indicated functions. Typical embodiments implement first perturbation module 120, sensitivity calculator 130, output mean calculator 140, standard deviation calculator 150, z-value calculator 160, probability display module 170, variance contribution calculator 180, variance contribution display module 190, second perturbation module 200, and live report generator 210 as software modules in a general purpose digital computer.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for characterizing a design function, said apparatus comprising:
a first perturbation module adapted for writing a first perturbed input value into an input cell of an input spreadsheet to generate a first perturbed output value of an output cell of an output spreadsheet; and
a sensitivity calculator adapted for calculating a design function sensitivity from said first perturbed input value and said first perturbed output value.

2. The apparatus of claim 1 further comprising an output mean calculator adapted for calculating an output mean from said design function sensitivity and from an input mean.

3. The apparatus of claim 2 wherein said output mean calculator is further adapted for using a second order approximation.

4. The apparatus of claim 1 further comprising a standard deviation calculator adapted for calculating an output standard deviation from said design function sensitivity and from an input standard deviation.

5. The apparatus of claim 4 further comprising a z-value calculator adapted for calculating a z-value from said output mean, said output standard deviation, an upper specification limit, and a lower specification limit.

6. The apparatus of claim 4 further comprising a probability display module adapted for displaying a bell curve using said output mean and said output standard deviation.

7. The apparatus of claim 6 wherein said probability display module is further adapted for displaying said upper specification limit and said lower specification limit as vertical lines on said bell curve.

8. The apparatus of claim 1 further comprising:
a variance contribution calculator adapted for calculating a plurality of variance contributions from a plurality of design function sensitivities,
said variance contributions corresponding to respective ones of a plurality of input cells,
said design function sensitivities corresponding to respective ones of said plurality of input cells,
said first perturbation module being further adapted for writing a plurality of first perturbed input values into corresponding ones of said plurality of input cells,
said sensitivity calculator being further adapted for calculating said plurality of design function sensitivities.

9. The apparatus of claim 8 further comprising a variance contribution display module adapted for displaying said variance contributions using a bar chart.

10. The apparatus of claim 1 further comprising:
a second perturbation module adapted for writing a second perturbed input value into said input cell to generate a second perturbed output value of said output cell, said second perturbed input value being greater than said first perturbed input value, and for displaying said second perturbed output value.

11. The apparatus of claim 1 further comprising a live report generator adapted for implementing a method comprising:
generating a live report spreadsheet;
copying said input spreadsheet to a copied input spreadsheet;
copying said output spreadsheet to a copied output spreadsheet;
optionally, copying at least one intermediate spreadsheet to at least one copied intermediate spreadsheet, said at least one intermediate spreadsheet linking said input spreadsheet to said output spreadsheet;
linking a live report input cell of said live report spreadsheet to a copied input cell of said copied input spreadsheet, said copied input cell corresponding to said input cell of said input spreadsheet; and
linking a live report output cell of said live report spreadsheet to a copied output cell of said copied output spreadsheet, said copied output cell corresponding to said output cell of said output spreadsheet.

12. An apparatus for characterizing a design function, said apparatus comprising:
a first perturbation module adapted for writing a first perturbed input value into an input cell of an input spreadsheet to generate a first perturbed output value of an output cell of an output spreadsheet;
a sensitivity calculator adapted for calculating a design function sensitivity from said first perturbed input value and said first perturbed output value;
an output mean calculator adapted for calculating an output mean from said design function sensitivity and from an input mean;
a standard deviation calculator adapted for calculating an output standard deviation from said design function sensitivity and from an input standard deviation;
a z-value calculator adapted for calculating a z-value from said output mean, said output standard deviation, an upper specification limit, and a lower specification limit;
a live report generator adapted for implementing a method comprising:
generating a live report spreadsheet;
copying said input spreadsheet to a copied input spreadsheet;
copying said output spreadsheet to a copied output spreadsheet;
optionally, copying at least one intermediate spreadsheet to at least one copied intermediate spreadsheet, said at least one intermediate spreadsheet linking said input spreadsheet to said output spreadsheet;
linking a live report input cell of said live report spreadsheet to a copied input cell of said copied input spreadsheet, said copied input cell corresponding to said input cell of said input spreadsheet; and
linking a live report output cell of said live report spreadsheet to a copied output cell of said copied output spreadsheet, said copied output cell corresponding to said output cell of said output spreadsheet.

13. The apparatus of claim 12 wherein said output mean calculator is further adapted for using a second order approximation.

14. The apparatus of claim 12 further comprising a probability display module adapted for displaying a bell curve using said output mean and said output standard deviation.

15. The apparatus of claim 14 wherein said probability display module is further adapted for displaying said upper specification limit and said lower specification limit as vertical lines on said bell curve.

16. The apparatus of claim 12 further comprising:
a variance contribution calculator adapted for calculating a plurality of variance contributions from a plurality of design function sesitivities,
said variance contributions corresponding to respective ones of a plurality of input cells,
said design function sensitivities corresponding to respective ones of said plurality of input cells,
said first perturbation module being further adapted for writing a plurality of first perturbed input values into corresponding ones of said plurality of input cells,
said sensitivity calculator being further adapted for calculating said plurality of design function sensitivities.

17. The apparatus of claim 16 further comprising a variance contribution display module adapted for displaying said variance contributions using a bar chart.

18. The apparatus of claim 12 further comprising:
a second perturbation module adapted for writing a second perturbed input value into said input cell to generate a second perturbed output value of said output cell, said second perturbed input value being greater than said first perturbed input value, and for displaying said second perturbed output value.

19. A method for characterizing a design function, said method comprising:
selecting an input cell from an input spread sheet;
selecting an output cell from an output spread sheet;
writing a first perturbed input value into said input cell to generate a first perturbed output value of said output cell; and
calculating a design function sensitivity from said first perturbed input value and said first perturbed output value.

20. The method of claim 19 further comprising calculating an output mean from said design function sensitivity and from an input mean.

21. The method of claim 20 wherein said step of calculating an output mean comprises using a second order approximation.

22. The method of claim 19 further comprising calculating an output standard deviation from said design function sensitivity and from an input standard deviation.

23. The method of claim 22 further comprising calculating a z-value from said output mean, said output standard deviation, an upper specification limit, and a lower specification limit.

24. The method of claim 22 further comprising displaying a bell curve using said output mean and said output standard deviation.

25. The method of claim 24 further comprising displaying said upper specification limit and said lower specification limit as vertical lines on said bell curve.

26. The method of claim 19 further comprising:
calculating a plurality of variance contributions from a plurality of design function sesitivities,
said variance contributions corresponding to respective ones of a plurality of input cells,
said design function sensitivities corresponding to respective ones of said plurality of input cells,
said step of selecting said input cell comprising selecting said plurality of input cells,
said step of writing said first perturbed input value comprising writing a plurality of first perturbed input values into corresponding ones of said plurality of input cells,
said step of calculating said design function sensitivity comprising calculating said plurality of design function sensitivities.

27. The method of claim 26 further comprising displaying said variance contributions using a bar chart.

28. The method of claim 19 further comprising:
writing a second perturbed input value into said input cell to generate a second perturbed output value of said output cell, said second perturbed input value being greater than said first perturbed input value; and
displaying said second perturbed output value.

29. The method of claim 19 further comprising:
generating a live report spreadsheet;
copying said input spreadsheet to a copied input spreadsheet;
copying said output spreadsheet to a copied output spreadsheet;
optionally, copying at least one intermediate spreadsheet to at least one copied intermediate spreadsheet, said at least one intermediate spreadsheet linking said input spreadsheet to said output spreadsheet;
linking a live report input cell of said live report spreadsheet to a copied input cell of said copied input spreadsheet, said copied input cell corresponding to said input cell of said input spreadsheet; and
linking a live report output cell of said live report spreadsheet to a copied output cell of said copied output spreadsheet, said copied output cell corresponding to said output cell of said output spreadsheet.

30. A method for characterizing a design function, said method comprising:
selecting an input cell from an input spread sheet;
selecting an output cell from an output spread sheet;
writing a first perturbed input value into said input cell to generate a first perturbed output value of said output cell;
calculating a design function sensitivity from said first perturbed input value and said first perturbed output value;
calculating an output mean from said design function sensitivity and from an input mean;
calculating an output standard deviation from said design function sensitivity and from an input standard deviation;
calculating a z-value from said output mean, said output standard deviation, an upper specification limit, and a lower specification limit;
generating a live report spreadsheet;
copying said input spreadsheet to a copied input spreadsheet;
copying said output spreadsheet to a copied output spreadsheet;
optionally, copying at least one intermediate spreadsheet to at least one copied intermediate spreadsheet, said at least one intermediate spreadsheet linking said input spreadsheet to said output spreadsheet;
linking a live report input cell of said live report spreadsheet to a copied input cell of said copied input spreadsheet, said copied input cell corresponding to said input cell of said input spreadsheet; and
linking a live report output cell of said live report spreadsheet to a copied output cell of said copied output spreadsheet, said copied output cell corresponding to said output cell of said output spreadsheet.

31. The method of claim 30 wherein said step of calculating an output mean comprises using a second order approximation.

32. The method of claim 30 further comprising displaying a bell curve using said output mean and said output standard deviation.

33. The method of claim 32 further comprising displaying said upper specification limit and said lower specification limit as vertical lines on said bell curve.

34. The method of claim 30 further comprising:
calculating a plurality of variance contributions from a plurality of design function sesitivities,
said variance contributions corresponding to respective ones of a plurality of input cells,
said design function sensitivities corresponding to respective ones of said plurality of input cells,
said step of selecting said input cell comprising selecting said plurality of input cells,
said step of writing said first perturbed input value comprising writing a plurality of first perturbed input values into corresponding ones of said plurality of input cells,
said step of calculating said design function sensitivity comprising calculating said plurality of design function sensitivities.

35. The method of claim 34 further comprising displaying said variance contributions using a bar chart.

36. The method of claim 30 further comprising:
writing a second perturbed input value into said input cell to generate a second perturbed output value of said output cell, said second perturbed input value being greater than said first perturbed input value; and
displaying said second perturbed output value.
